(19) United States
(12) Patent Application Publication
(10) Pub. No.: US 2003/0159247 A1
(43) Pub. Date: Aug. 28, 2003

(54) Vehicle hood hinge

(75) Inventor: Randall T. Schott, Bowling Green, OH (US)

Correspondence Address: BROOKS & KUSHMAN, 1000 TOWN CENTER 22ND FL, SOUTHFIELD, MI, 48075

(73) Assignee: Midway Products Group, Inc., Monroe, MI

(21) Appl. No.: 10/082,574

(22) Filed: Feb. 25, 2002

(51) Int. Cl. E05D 7/04

(52) U.S. Cl. 16/244

(57) ABSTRACT

A vehicle body hood hinge (24) includes a pivotal connector (32) that extends between a vehicle body hinge member (28) and a hood hinge member (30) to permit adjustment so that the hood is flush with the vehicle body in a closed position. The pivotal connector (32) includes a connection member 34 having an adjustment pivotal connection (36) on the vehicle body hinge member and an adjustable positioning connection (38) that secures the connection member in an adjusted position, while a main pivotal connection (40) of the pivotal connector includes a bushing (42) and a pintle (44) that cooperate to permit pivotal movement of the hinge between hood open and closed positions and to also permit adjustable positioning of the mounted hood with respect to the vehicle body.

### BACKGROUND OF THE INVENTION

1. Field of the Invention

This invention relates to a vehicle hood hinge for mounting a vehicle hood for movement between open and closed positions with respect to an engine compartment opening of an associated vehicle body.

2. Background Art

Vehicle bodies conventionally include an engine compartment opening that is opened and closed by a hood mounted by a pair of laterally spaced hinges. Such hoods are conventionally now mounted by a pair of hinges located at opposite lateral sides of the rear extremity of the engine compartment opening just forward of the vehicle windshield. In order to facilitate pivoting movement of the hinges, it is conventional for the pivotal connection of each hinge to include a bushing of an annular shape with an axially extending portion and a pair of annular flanges that extend from the axially extending portion. Such pivotal connections have previously included an arcuate slot and a threaded stud and nut connection that permits adjustability of the location of the hood with respect to the vehicle body so that there is a flush transition between the vehicle body and the hood at the engine compartment opening. However that construction when utilized with a dual flanged bushing type hinge of the conventional type results in the securement being only at diametrical opposite spaced portions of the bushing flanges such that the bushings can wear and thereby loosen from their adjusted position after a certain number of opening and closing cycles of the hinge.

### SUMMARY OF THE INVENTION

An object of the present invention is to provide an improved vehicle body hood hinge.

In carrying out the above object, the vehicle hood hinge of the invention includes a vehicle body hinge member for mounting on a vehicle body adjacent an engine compartment opening, and the hinge also includes a hood hinge member for mounting to a vehicle hood for closing and opening the engine compartment. A pivotal connector of the hood includes a connector member having an adjustment pivotal connection to one of the hinge members. An adjustable positioning connection adjustably secures the connection member to the one hinge member in an adjusted position about the adjustment pivotal connection. A main pivotal connection of the hinge includes an annular bushing and a pintle that cooperate to pivotally mount the other hinge member on the connection member at a location between the adjustment pivotal connection and the adjustable positioning connection to permit pivotal movement of the hinge between hood open and closed positions and to also permit adjustable positioning of the mounted hinge with respect to the vehicle body.

With the construction of the hood hinge, the bushing of the main pivotal connection is engaged for 360° with the associated pintle and supported so as to not wear during use.

In the preferred construction of the vehicle hood hinge, the vehicle body hinge member includes a generally horizontally extending mounting flange for mounting thereof on the vehicle body and the hood hinge has a mounting flange for mounting to the hood in a generally horizontal orientation with the hood in the closed position with respect to the engine compartment. The hinge members have vertically extending connection flanges between which the pivotal connector extends to adjustably pivotally connect the hinge members.

In the preferred construction, the connector member of the pivotal connector is adjustably pivotally mounted by the adjustment pivotal connection and the adjustable positioning connection on the vehicle body hinge member. Furthermore, the main pivotal connection pivotally mounts the hood hinge member on the connector member for pivotal movement with respect to the vehicle body hinge member.

The preferred construction of the vehicle body hinge also has the adjustable positioning connection constructed to include a threaded stud fixedly secured to the one hinge member on which the connection member is mounted. An arcuate slot of the adjustable positioning connection extends through the connection member about the adjustment pivotal connection with the threaded stud extending therethrough, and a nut is threadedly received by the threaded stud to permit adjustment and securement of the adjustable positioning connection.

The preferred construction of the vehicle hood hinge has the hinge members provided with stops that engage each other to limit pivotal movement of the hood hinge member with respect to the vehicle body hinge member. The stop of the one hinge member on which the connection member is located is provided at a location between the adjustment pivotal connection and the adjustable positioning connection, and the stop of the other hinge member extends therefrom on the opposite side of the main pivotal connection.

The preferred construction of the vehicle hood hinge also has the hinge members provided with retainers that provide positioning of the hinge members with respect to each other in the closed position of the hinge. The retainers are preferably provided as an opening in one of the hinge members and a projection on the other hinge member, and the opening receives the projection with the hinge in the closed position to provide positioning of the hinge members with respect to each other.

The objects, features and advantages of the invention are readily apparent from the following detailed description of the preferred embodiment when taken in connection with the accompanying drawings.

### BRIEF DESCRIPTION OF THE DRAWINGS

FIG. 1 is a partial view of a vehicle body having a front engine compartment opening that is opened and closed by a hood movable between the solid line indicated closed position and the open position that is shown partially by phantom line representation.

FIG. 2 is a side elevational view illustrating the hood hinge of the invention shown in a hood open position and with a nut of an adjustable positioning connection removed to better illustrate the construction.

FIG. 3 is a sectional view taken along the direction of line 3-3 in FIG. 2 through an adjustable positioning connection of the hinge.

FIG. 4 is a sectional view taken along the direction of line 4-4 in FIG. 2 through a main pivotal connection of the hinge.

FIG. 5 is an enlarged partial view of a portion of a bushing of the main pivotal connection shown in FIG. 4.

FIG. 6 is a top plan view of the hinge.

FIG. 7 is a side elevational view of the hinge taken in its closed position along the direction of line 7-7 in FIG. 6.

### DETAILED DESCRIPTION OF THE PREFERRED EMBODIMENT

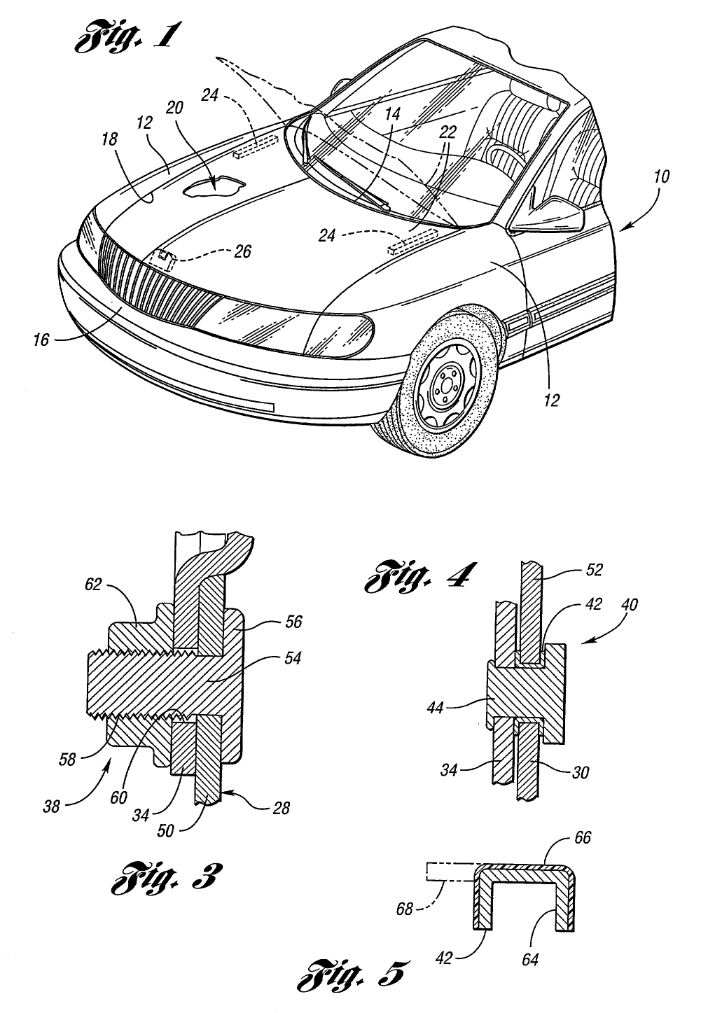

With reference to FIG. 1, a partially illustrated vehicle body 10 has front quarter panels 12, a windshield lower header 14, and a front end 16 that cooperate to define an opening 18 of the vehicle engine compartment 20. A hood 22 of the vehicle body is pivotally mounted by a pair of vehicle hood hinges 24 for movement between the solid line indicated closed position and the partially indicated phantom line open position. These vehicle hood hinges 24 are constructed in accordance with the present invention and are located at the opposite lateral sides of the engine compartment opening 18 adjacent its rear extremity. A conventional hood latch 26 at the forward extremity of the engine compartment opening 18 provides securement of the hood 22 in the closed position while unlatching thereof selectively permits movement of the hood to the open position by pivoting about the vehicle hood hinges 24 as is hereinafter more fully described.

As illustrated in FIGS. 2, 6 and 7, the vehicle hood hinge 24 of the invention includes a vehicle body hinge member 28 that is mounted on the vehicle body 10 adjacent one lateral side of the rear extremity of the engine compartment opening previously described, with suitable fasteners being utilized to secure this hinge member in position. The vehicle hood hinge also includes a hood hinge member 30 for mounting to the vehicle hood with securement being provided by suitable fasteners such that the hood is supported for closing and opening movement with respect to the engine compartment as was also previously described. A pivotal connector 32 of the hinge includes a connector member 34 having an adjustment pivotal connection 36 to the vehicle body hinge member 28. The connector member 34 as illustrated in FIG. 2 extends to the right from the adjustment pivotal connection 36 and is pivotal thereabout to provide adjustment of the hinge as is hereinafter more fully described. An adjustable positioning connection 38 of the pivotal connector adjustably secures the connector member 34 to the vehicle body hinge member 28 in an adjusted position about the adjustment pivotal connection 36. A main pivotal connection 40 of the pivotal connector 32 is illustrated in FIG. 4 as including an annular bushing 42 and a pintle 44 that cooperate to pivotally mount the hood hinge member 30 on the connection member 34 at a location as shown in FIG. 2 between the adjustment pivotal connection 36 and the adjustable positioning connection 38. The adjustable pivoting of the connection member 34 raises and lowers the main pivotal connection 40 so that the hood 22 in the closed position can have a flush junction with the adjacent vehicle body portion in the closed position of the hood. Upward and downward movement for about 4 mm is sufficient to provide for tolerance variations involved with the vehicle body and the hood. The hood hinge 24 thus permits pivotal movement of the hinge between the hood open position and the closed position and also permits the adjustable positioning of the mounted hood with respect to the vehicle body to provide the flush junction adjacent the engine compartment opening.

As shown in FIGS. 2, 6 and 7, the vehicle body hinge member 28 has an L shape including a generally horizontally extending mounting flange 46 for mounting thereof on the vehicle body. Likewise, the hood hinge member 30 has an L shape including a mounting flange 48 for mounting to the hood 22 in a generally horizontal orientation with the hood in the closed position with respect to the engine compartment of the vehicle body. The L shapes of the vehicle body hinge member 28 and the hood hinge member 30 also have vertically extending flanges 50 and 52, respectively, between which the pivotal connector 32 extends to adjustably pivotally connect the hinge members. While it is possible for the pivotal connector 32 to be mounted for adjustment on the hood hinge member 30 for adjustment by the cooperation of the adjustment pivotal connection 36 and the adjustable positioning connection 38, the preferred construction illustrated has the pivotal connector mounted on the vehicle body hinge member 28 as described above to facilitate the adjustment and positioning of the hood to the proper vertical position. With this construction, the main pivotal connection 40 thus pivotally mounts the hood hinge member 30 for pivotal movement with respect to the vehicle body hinge member 28 on which the pivotal connector is mounted.

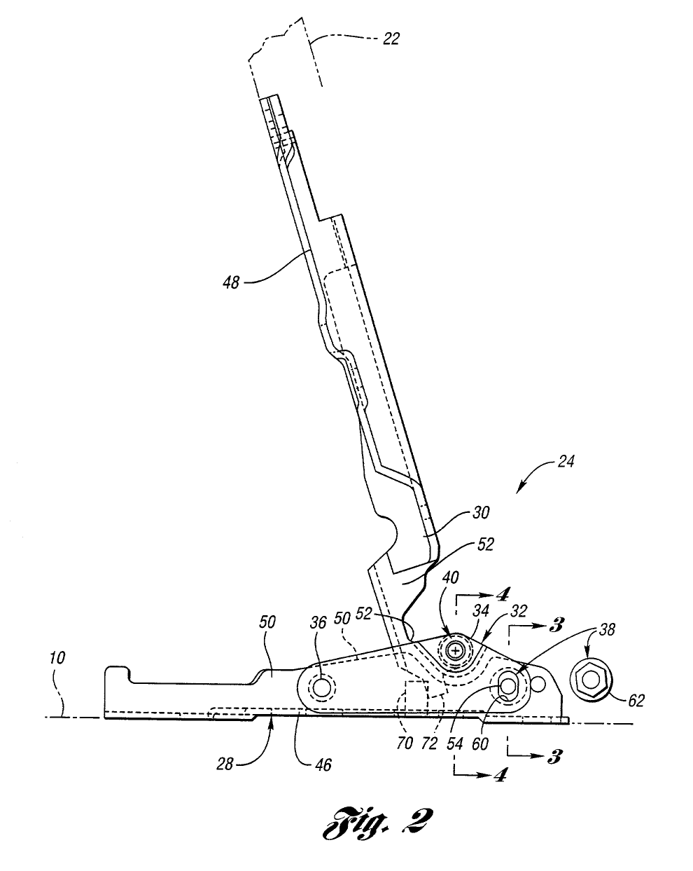

With reference to FIG. 3, the adjustable positioning connection 38 includes a threaded stud 54 having a head 56 that is secured to the vehicle body hinge member 28 and also having a threaded shank 58 that extends from the head through a hole in the vehicle body hinge member. An arcuate slot 60 of the adjustable positioning connection extends through the connector member 34 as shown in FIG. 2 about the adjustment pivotal connection with the threaded shank 58 of the stud extending therethrough. A threaded nut 62 is threadedly received by the threaded shank 58 of stud 54. Loosening of the nut 62 permits pivotal adjustment of the connection member 34 about the adjustment pivotal connection 36 shown in FIG. 2, while tightening of the nut 62 secures the connection member 34 in an appropriate adjusted position.

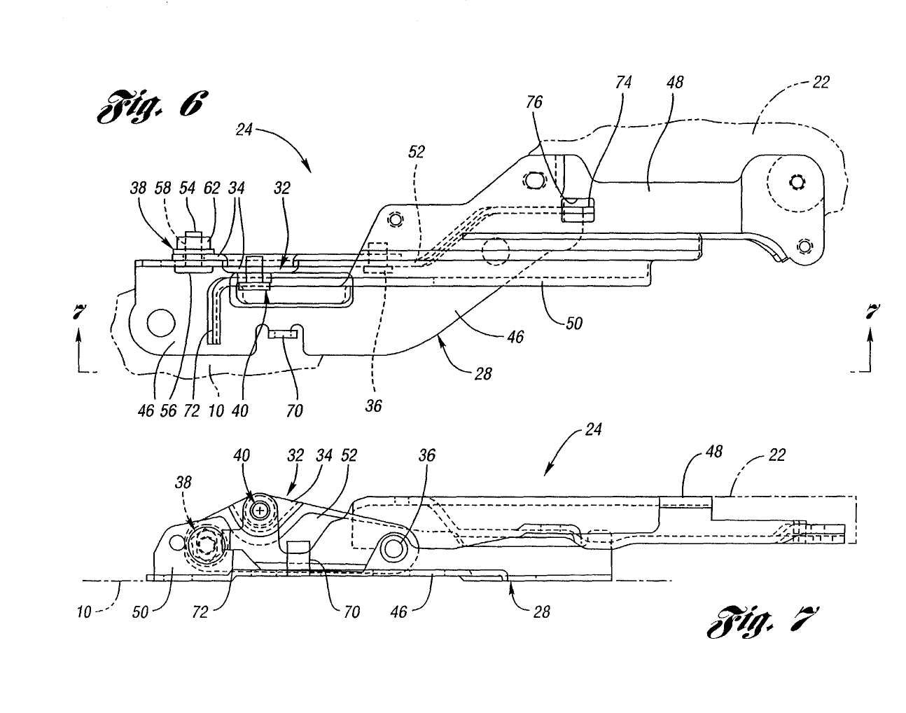

The main pivotal connection 40 illustrated in FIG. 4 has the annular bushing 42 constructed as also shown in FIG. 5 from a metallic bushing member 64 having a lubricious coating 66 of a suitable synthetic resin. The bushing initially has a phantom line indicated annular portion 68 that is inserted through a hole in the hood hinge member and then deformed as shown by solid line representation in FIG. 5. As previously mentioned, the construction of the hood hinge permits this bushing 42 to have a full 360° support as compared with prior adjustable hood hinges where the bushing is only supported at diametrically opposes ides of the pintle adjacent sides of the associated adjustable slot.

As illustrated in FIGS. 2, 6 and 7, the vehicle body and hood hinge members 28 and 30 have stops 70 and 72, respectively, that engage each other as shown in FIG. 2 to limit the pivotal movement of the hood hinge member with respect to the vehicle body hinge member. More specifically, the vehicle body hinge member stop 70 is formed from its mounting flange 46 extending in an upward direction between the adjustment pivotal connection 36 and the adjustable positioning connection 38. Furthermore, the stop 72 of the hood hinge member 22 extends therefrom on the opposite side of the main pivotal connection 40 as illustrated in FIGS. 5 and 6.

As best illustrated in FIGS. 6 and 7, the vehicle body and hood hinge members 28 and 30 also have retainers 74 and 76 that provide positioning of the hinge members with respect to each other in the closed position of the hinge. More specifically, relative horizontal movement is prevented by the retainers 74 and 76 so as to thereby maintain the hood fixed with respect to the vehicle body such as during deformation of the vehicle upon a collision. More specifically, the vehicle body hinge member retainer 74 is constructed as a upward projection and the hood hinge member retainer 76 is constructed as an opening that receives the vehicle body projection retainer 74 with the hinge in the closed position to provide such positioning of the hinge members with respect to each other.

While the preferred embodiment for carrying out the invention has been described in detail, those familiar with the art to which this invention relates will recognize various alternative designs and embodiments for practicing the invention as defined by the following claims.

What is claimed is:

1. A vehicle hood hinge comprising:
a vehicle body hinge member for mounting on a vehicle body adjacent an engine compartment opening;
a hood hinge member for mounting to a vehicle hood for closing and opening the engine compartment; and
a pivotal connector including: a connector member having an adjustment pivotal connection to one of the hinge members, an adjustable positioning connection for adjustably securing the connector member to the one hinge member in an adjusted pivotal position about the adjustment pivotal connection, and a main pivotal connection including an annular bushing and a pintle that cooperate to pivotally mount the other hinge member on the connection member at a location between the adjustment pivotal connection and the adjustable positioning connection to permit pivotal movement of the hinge between hood open and closed positions and to also permit adjustable positioning of the mounted hood with respect to the vehicle body.

2. A vehicle hood hinge as in claim 1 wherein the vehicle body hinge member includes a generally horizontally extending mounting flange for mounting thereof on the vehicle body, the hood hinge member having a mounting flange for mounting to the hood in a generally horizontal orientation with the hood in the closed position with respect to the engine compartment, and the hinge members having vertically extending connection flanges between which the pivotal connector extends to adjustably pivotally connect the hinge members.

3. A vehicle hood hinge as in claim 1 wherein the connector member of the pivotal connector is adjustably pivotally mounted by the adjustment pivotal connection and the adjustable positioning connection on the vehicle body hinge member, and the main pivotal connection pivotally mounting the hood hinge member on the connector member for pivotal movement with respect to the vehicle body hinge member.

4. A vehicle hood hinge as in claim 1 wherein the adjustable positioning connection includes: a threaded stud fixedly secured to the one hinge member; an arcuate slot extending through the connector member about the adjustment pivotal connection with the threaded stud extending therethrough; and a nut threadedly received by the threaded stud to permit adjustment and securement of the adjustable positioning connection.

5. A vehicle hood hinge as in claim 1 wherein the hinge members have stops that engage each other to limit the pivotal movement of the hood hinge member with respect to the vehicle body hinge member.

6. A vehicle hood hinge as in claim 5 wherein the stop of the one hinge member is located between the adjustment pivotal connection and the adjustable positioning connection, and the stop of the other hinge member extending therefrom on the opposite side of the main pivotal connection.

7. A vehicle hood hinge as in claim 1 wherein the hinge members have retainers that provide positioning of the hinge members with respect to each other in the closed position of the hinge.

8. A vehicle hood hinge as in claim 7 wherein the retainers are an opening in one of the hinge members and a projection on the other hinge member, and the opening receiving the projection with the hinge in the closed position to provide the position of the hinge members with respect to each other.

9. A vehicle hood hinge comprising:
a vehicle body hinge member including a generally horizontally extending mounting flange for mounting thereof on a vehicle body adjacent an engine compartment opening, and the vehicle body hinge member also having a vertically extending connection flange;
a hood hinge member including a mounting flange for mounting to a vehicle hood the hood for closing and opening the engine compartment, and the hood hinge member also having a vertically extending connection flange;
a pivotal connector including: a connector member having an adjustment pivotal connection to the connection flange of the vehicle body hinge member, an adjustable positioning connection for adjustably securing the connector member to the connection flange of the vehicle body hinge member in an adjusted pivotal position about the adjustment pivotal connection, and a main pivotal connection including an annular bushing and a pintle that cooperate to pivotally mount the connection flange of the hood hinge member on the connection member at a location between the adjustment pivotal connection and the adjustable positioning connection to permit pivotal movement of the hinge between hood open and closed positions and to also permit adjustable positioning of the mounted hood with respect to the vehicle body.

10. A vehicle hood hinge comprising:
a vehicle body hinge member including a generally horizontally extending mounting flange for mounting thereof on a vehicle body adjacent an engine compartment opening, and the vehicle body hinge member also having a vertically extending connection flange;
a hood hinge member including a mounting flange for mounting to a vehicle hood the hood for closing and opening the engine compartment, and the hood hinge member also having a vertically extending connection flange; and
a pivotal connector including: a connector member having an adjustment pivotal connection to the connection flange of the vehicle body hinge member; an adjustable positioning connection including a threaded stud fixedly secured to the vehicle body hinge member, an arcuate slot extending through the connector member about the adjustment pivotal connection with the threaded stud extending therethrough, and a nut threadedly received by the threaded stud to permit adjustment and securement of the adjustable positioning connection for adjustably securing the connector member to the connection flange of the vehicle body hinge member in an adjusted pivotal position about the adjustment pivotal connection; and a main pivotal connection including an annular bushing and a pintle that cooperate to pivotally mount the connection flange of the hood hinge member on the connection member at a location between the adjustment pivotal connection and the adjustable positioning connection to permit pivotal movement of the hinge between hood open and closed positions and to also permit adjustable positioning of the mounted hood with respect to the vehicle body;
the hinge members having stops that engage each other to limit the pivotal movement of the hood hinge member with respect to the vehicle body hinge member; and
the hinge members having retainers that provide positioning of the hinge members with respect to each other in the closed position of the hinge.
